(19) United States
(12) Patent Application Publication
(10) Pub. No.: US 2006/0130100 A1
(43) Pub. Date: Jun. 15, 2006

(54) Methods and apparatus for remotely displaying and distributing advertising and emergency information

(76) Inventor: Joseph D. Pentland, Coeur d'Alene, ID (US)

Correspondence Address: KEITH S BERGMAN;ATTORNEY AT LAW, 7 SOUTH HOWARD STREET, SUITE 418, SPOKANE, WA, 992013898, US

(21) Appl. No.: 11/247,605

(22) Filed: Oct. 11, 2005

Related U.S. Application Data
(60) Provisional application No. 60/617,089, filed on Oct. 12, 2004.

(51) Int. Cl. H04N 7/20

(52) U.S. Cl. 725/68; 725/71

(57) ABSTRACT

The present invention relates to novel combinations of apparatus and methods useful for remotely displaying and distributing video advertising and emergency information via a satellite or other wireless system. Specifically, the present invention provides a satellite system to display and distribute video advertisements and emergency information to remote locations. The present invention further relates to a method for selecting advertising and emergency information to display on the satellite system. The present invention also relates to a system for displaying such information on shopping carts.

### RELATED APPLICATIONS

This Application claims the benefit of the priority of the filing date of the Provisional Application filed by the instant inventor on Oct. 12, 2004 under Application No. 60/617,089, Confirmation No. 7230.

### FIELD OF INVENTION

The present invention relates to novel apparatus and methods useful for remotely displaying and distributing video and/or audio and in particular video and/or audio advertisements and emergency information via a satellite or other wireless system. Specifically, the present invention provides a satellite system to display and distribute video advertising and emergency information to remote locations. The present invention further relates to methods for selecting, storing and distributing such video and/or audio information for display via the satellite system.

### BACKGROUND AND DESCRIPTION OF PRIOR ART

Advertising significantly influences consumer purchases. Each year, businesses spend millions of dollars in product advertising to assert or reinforce brand recognition and educate the public. Ultimately, businesses rely on advertisements to attract or maintain consumers who purchase their products. Advertisements are often presented in the form of billboards, printed promotions, radios and television commercials, and electronic displays. Advertisers seek to place their ads in places where they will be seen by a large number of people, and target their advertising toward people or groups that are likely to purchase their products or services. Placing the best advertisement in front of the best target audience is paramount to a good advertising scheme. There is a constant need for innovative means to place high quality advertising in front of a highly receptive audience at the right time and at the right location.

Effective advertising can involve strategic placement of billboards and other large displays that can be seen by consumers outside of shopping areas. Many large billboards are strategically placed alongside highways and major roads. The billboards can display advertisements that reinforce brand recognition or identify the location and/or availability of certain goods and products. Advertisements are currently being displayed on mobile structures such as trucks, vans, buses, and taxis. Because of their mobile nature, such advertisements are typically intended to reinforce brand recognition as they are viewed in passing by consumers.

Current advertising display are often limited to advertising one product or service. Advances have provided roll-up kiosks or billboards having displays that flip or rotate to present multiple advertisements on the same kiosk or billboard. These advances are limited to the physical limitations of the advertising system. Such systems typically have limited content and do not change content depending on the time of day, or the day of the week, or in conjunction with holidays or special occasions.

Additionally, advertising requirements change dynamically in response to economic effects, social pressures, world events, product supply, consumer demand, and many other factors. Typical advertising displays, however, are not adaptive to accommodate such changes. Billboards, for instance, take time and manpower to replace outdated advertising. Kiosks at shopping centers may also take manpower and time to replace the physical advertising. Moreover, the time and manpower required to change an entire advertising scheme may be significant if an advertiser uses multiple advertising resources. Because of the required time and manpower to change advertising, there may be a significant lag between the time a new message should be displayed and the time it is actually displayed to consumers. As such, there is a need in the art for advertising that may be changed or modified in real time.

Finally, mass media effectively promulgates important messages. In case of an emergency, both television and radio stations have emergency response policies in place not only to provide news but also to communicate vital and valuable information to their viewers and listeners. With the heightened attention to security, in light of recent acts of terrorism and natural disasters, there is an increased need to disseminate urgent security information, warnings and alerts to as many people as possible and as quickly and efficiently as possible. This emergency communication and advertising ability cooperate synergetically to materially aid both processes significantly beyond prior limitations.

### SUMMARY OF THE INVENTION

The present invention relates to novel combinations of apparatus and methods useful for remotely displaying and distributing video and/or audio, and in particular, video and/or audio advertisements and emergency information, via a satellite system. In one embodiment, the system comprises a satellite receiver in communication with a satellite uplink station, a controller coupled with the satellite receiver, a storage device in association with the controller configured to store data received from the controller via the satellite receiver, and at least one video display coupled with a controller. In another embodiment, the system further comprises at least one video signal processor coupled with a video display. In another embodiment, the system isolates one channel of a multi-channel video signal for presentation on at least one video display. The invention may also isolate at least one channel of a multi-channel video signal for storage in the storage device. In alternative embodiments, the system may further comprise a speaker system associated with the video display for broadcasting audio.

In another embodiment, the video display is mobile and mounted on a vehicle. In another embodiment, the video display is mounted on a stationary surface that may be a billboard, a kiosk, marquis, business signage, or a wall. The video display may be mounted inside a building such as a mall, airport, bus station, grocery store, convention center, restaurant, bar, sports stadium, subway station, waiting room, airport, government facility, train station, or any other area where the public congregates. The video display comprises a projector capable of projecting the video signal onto a surface such as a screen, wall, ceiling, or floor.

In another embodiment, the video display may comprise of a plurality of video display units. Each video display unit may be modular, allowing each video display unit to be replaced individually. Each video display unit may be about one foot wide by one foot high and may be a flat screen display. The video display may also be an LCD display, plasma display, television, LED display, computer monitor, touch screen displays, or any other display known in the art. In another embodiment, the video processor may split a single channel video signal into multiple video signals. Each split signal may be represented on a single video display unit of a video display matrix, so that each video display unit displays a portion of the video channel. The incoming video signal may be a multi-channel video signal. The controller may isolate one or more channels of a multi-channel signal for storage or display.

In another embodiment, the video display is protected by an industrial protective cover to protect the video display from the elements, theft, vandalism, or damage.

In yet another embodiment, the system may include a global positioning system (GPS), which communicates the geographic location of the video display to the controller. The controller may send different videos from the storage device or from a live feed to the video display for display on the video display depending on the geographic position of the video display as determined by the GPS. In another aspect of the invention, the controller may send different videos from the storage device or from a live feed to the video display depending the time of day, the day of the week, holidays, the month, the year, the weather or other environmental condition. In yet another aspect of the invention, the system displays advertisements, sports, cartoons, AMBER alerts, news, weather reports, terrorism threats, traffic reports, and security warnings.

In a further aspect of the invention, the system may display live satellite broadcasts obtained from the satellite uplink station via the satellite. The video display may be remotely interrupted via satellite to display AMBER alerts, vital news, weather reports, terrorism threats, traffic reports, or security warnings. The interruptions may be video data that is live video data, recorded video data, or video data stored in the storage device.

In another embodiment, the controller may receive programming instructions from the uplink station via the satellite. The programming instructions may include start time of a video signal, end time of a video signal, geographic location in which to display video data, selection of received channels to store in the storage device, program overrides, display of live signals, or commands to display a sequence of a series of video files.

In yet another embodiment, the controller sends video data to the video display via wireless networking, Bluetooth® technology, coaxial cable, WiFi, WiMAX, DSL, ISDN, RCA® cables, the internet, or an intranet. In a further embodiment, the controller and storage device may send data to and store data for a plurality of video signal processors and video signal generators associated with video displays.

Another embodiment of the present invention provides methods for selecting advertising or programming to display on the video displays of the system. The method may include communicating the geographic location of the video display to the controller. The system may be mobile and may also include a plurality of video display units in one video display. The programming may be commercial advertising or programming and may be associated with a fee. A further embodiment provides a fee for commercial advertising or programming that may be determined by a plural of variables such as geographic location of the system, duration of the commercial advertising or programming, size of the video display used in the system, day of the week, time of day, and the number of other video displays in the system.

In another embodiment of the present invention, the video display may be mounted on a shopping cart. The video display may communicate with the controller via WiFi, WiMAX, Bluetooth®, or other wireless technology. The video display may be positioned on the shopping cart to be viewed by the operator of the shopping cart. The video display may present advertisements according to the location of the shopping cart within a store. The video display may also present electronic coupons to the shopper, include a card reader and also be a touch screen display.

Another embodiment of the present invention may include a central communication hub and at least one system comprising a shopping cart and a video display in communication with the communication hub and attached to the shopping cart, wherein the communication hub directs images displayed on the video display. The video display may communicate with the controller via WiFi, WiMAX, Bluetooth®, or other wireless technology. The video display may be a touch screen display for user input, which may be communicated to the central communication hub. The video display may also include a card reader. The communication hub may be a computer or coupled with a computer. The system may include a location sensor coupled with the video display to communicate location of the shopping cart to the central hub. The communication hub may vary images displayed on the video display responsive to the location of the shopping cart within a store. A speaker system may be coupled with the video display. The video display may also coupled with rechargeable batteries and means for recharging these batteries. The video display may present coupons and advertisements to a shopper.

Another embodiment of the present invention provides methods for display of emergency information upon interruptive demand. The method includes communicating emergency information from the uplink station to the controller via the satellite receiver for immediate and future transmittal to the video display. The emergency information may comprise videos from the storage device or from a live feed uploaded from the controller or video signal input from one or more video signal generators associated with the video display and video display units. The video display may include audio and at least one internet, intranet, radio and land line serviced display unit. The video display may selectively provide emergency information to publically available video display units, governmental entities and agencies, and public and private information systems in interruptive and non-interruptive format.

### BRIEF DESCRIPTIONS OF DRAWINGS

FIG. 1 is a drawing of one embodiment of a satellite advertising system.

FIG. 2 is a drawing of one embodiment of the present invention representing the flow of a video signal from receiver to display.

FIG. 3 is a drawing of one embodiment of the present invention representing the flow of a video signal from receiver to display with a representation of a global positioning system.

FIG. 4 is a drawing of one embodiment of the present invention representing a system with multiple video displays.

FIG. 5 is a drawing of one embodiment of the present invention representing a system that communicates with a plurality of video displays via a wireless system.

FIG. 6 is a drawing of another embodiment of the present invention representing a system that communicates with a plurality of displays via a wireless system.

FIG. 7 is a drawing of another embodiment of the present invention showing a fleet of trailers with video displays.

FIG. 8 is a drawing of another embodiment of the present invention showing a display with a speaker system.

FIG. 9 is a drawing of another embodiment of the present invention showing a video display mounted on a shopping cart.

FIG. 10 is a drawing showing an alternative placement of the video display on a shopping cart.

FIG. 11 is a drawing of another embodiment of the present invention showing a communication hub in communication with three video displays mounted to shopping carts.

FIG. 12 is a drawing of the present invention showing a system particularly adapted to display of both advertising and emergency information.

### DETAILED DESCRIPTION OF INVENTION

It is to be understood that the present invention is not limited to the particular methodology, compounds, materials, manufacturing techniques, uses, and applications described herein, as these may vary. It is also to be understood that the terminology used herein is used for the purpose of describing particular embodiments only, and is not intended to limit the scope of the present invention. It must be noted that as used herein and in the appended embodiments, the singular forms “a”, “an”, and “the” include the plural reference unless the context clearly dictates otherwise. Thus, the example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the more inclusive sense possible. Thus, the word “or” should be understood as having the definition of a logical “or” rather than that of a logical “exclusive or” unless the context clearly necessitates otherwise. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. All references cited herein are incorporated by reference herein in their entirety.

The word “video” when used in the context of the present invention, includes both video and/or audio signals, which may be analog, digital, or any appropriate combination thereof, and also may include single or multi-channel video and/or audio signals.

The words “satellite receiver” when used in the context of the present invention, include any device capable of receiving data from a satellite and capable of sending the received data to another device.

The words “satellite uplink station” when used in the context of the present invention, include an apparatus capable of transmitting data to a satellite.

The word “controller” when used in the context of the present invention, includes any device capable of controlling the individual devices of the present invention, including receiving data from a satellite receiver, and/or sending data to a storage device, and/or receiving data from a storage device, and/or sending data to at least one video display. Additionally the controller may communicate with a GPS system and perform programming instructions.

The words “storage device” when used in the context of the present invention, include any device capable of storing analog or digital data received from the satellite receiver and storing any controller programming instructions. The storage device may also include a device that communicates with a controller by receiving controller requests from data and sending the appropriate data to the controller. The storage device may be any known storage media known in the art.

The words “video signal processor” when used in the context of the present invention, include any device capable of processing a single video signal for presentation across a video display matrix, by receiving, from wireless or non-wireless means, a single video signal, processing the signal for, and sending a video signal to each video display unit in a video display matrix, each signal representing a portion of the video to display on a single video display unit.

The words “video display” when used in the context of the present invention, include any device that receives a video signal and displays video data associated with the signal. A video display may also include a single display or a plurality of displays arranged in a video display matrix. A video display may also include a speaker system.

The words “video display matrix” when used in the context of the present invention, include a plurality of video display units coupled together, each of which displays a portion of a video signal such that together the entire video signal is displayed across the video display units.

The words “programming instructions” when used in the context of the present invention, include computer executable code that when operated or followed by a controller instruct the controller to display, receive, and/or organize video data including, among others, display durations, start times, stop times, real time overrides, and/or location-specific start and stops.

The words “video data” when used in the context of the present invention, include any combination of electronically or magnetically recorded information that may be converted or presented on a screen or projected onto a surface and may be analog or digital.

The words “communicating”, “coupled”, “association” and any derivation thereof relate to the interaction between two devices and include both wireless and non-wireless means.

The words “sending”, “receiving”, and any derivation thereof include both wireless and non-wireless means.

The detailed descriptions which follow may be presented in terms of program procedures executed on a computer or network of computers. These procedural descriptions and representations are the means used by those skilled in the art to most effectively covey the substance of their work to others skilled in the art.

A procedure is, here and generally, conceived to be a self-consistent sequence of steps leading to a desired result. These steps are those requiring physical manipulations of physical quantities. Usually, though not necessarily, these quantities take the form of electrical or magnetic signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to these quantities.

Further, the manipulations performed are often referred to in terms, such as adding or comparing, which are commonly associated with mental operations performed by a human operator. No such capability of a human operator is necessary, or desirable in most cases, in any of the operations described herein which form part of the present invention; the operations are machine operations. Useful machines for performing the operation of the present invention include general-purpose digital computers or similar devices.

The present invention also relates to apparatus for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove more convenient to construct more specialized apparatus to perform the required method steps. The required structure for a variety of these machines will appear from the description given.

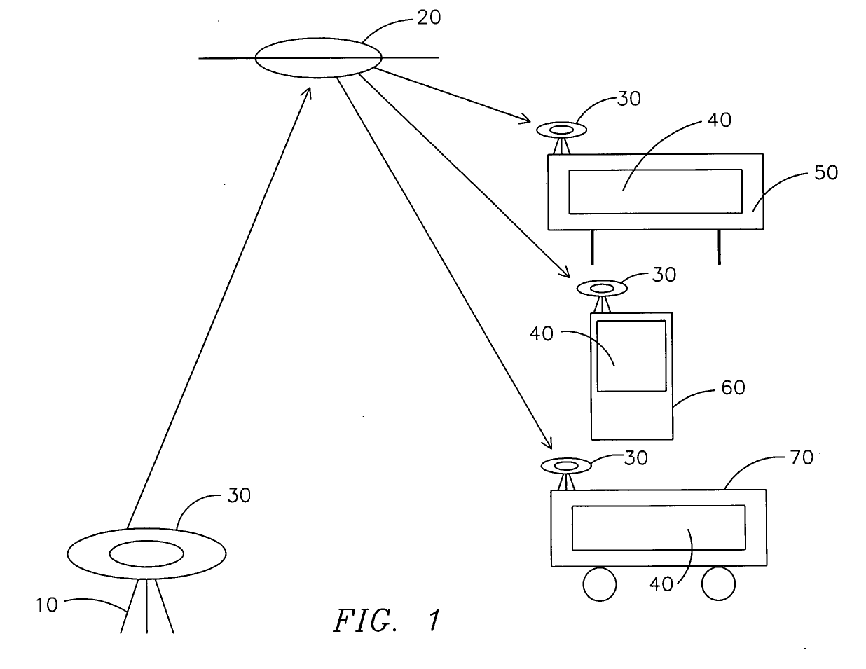

Referring to the figures, FIG. 1 is a representation of one embodiment of a system of the present invention and, in particular, a satellite advertising system. The advertising may be commercial advertising or programming and may, for example, include motion picture trailers or previews, TV-like commercials, or still billboard-like images. A satellite uplink station 10 sends a multi-channel video and/or audio signal to a satellite 20. The satellite 20, in turn, relays a video signal to one or more satellite receivers 30. These receivers, for example, are located on a billboard 50, a kiosk 60, and a mobile trailer 70, each with a video display 40. The satellite receivers 30 are located on, or associated with, any appropriate stationary or mobile location. This representation of the present invention in FIG. 1 shows how one satellite uplink station 10 may provide video signals to a plurality of advertising video displays 40 that are in the field, whether mobile or stationary. Each advertising system is instructed to select one channel from a multi-channel video signal to display on video display 40 and/or instructed to save any number of channels of the received video signal for future display. A controller 100 may comprise a general purpose computer and receives programming instructions from the satellite uplink station 10 via the satellite 20. The programming instructions may include start time to display video signals, end time of video signal, geographic location in which to display video information, which received channels to store in a storage device, program override, display current signal, and display sequence of a series of video files. In one embodiment, the advertising is commercial advertising or programming and its display on the systems of the present invention is associated with a fee. Such a fee is determined by one or more variables, which include the geographic location of the system, duration of the commercial advertising or programming, size of the video display used in said system, day of the week, time of day, and the number of other video displays in the system.

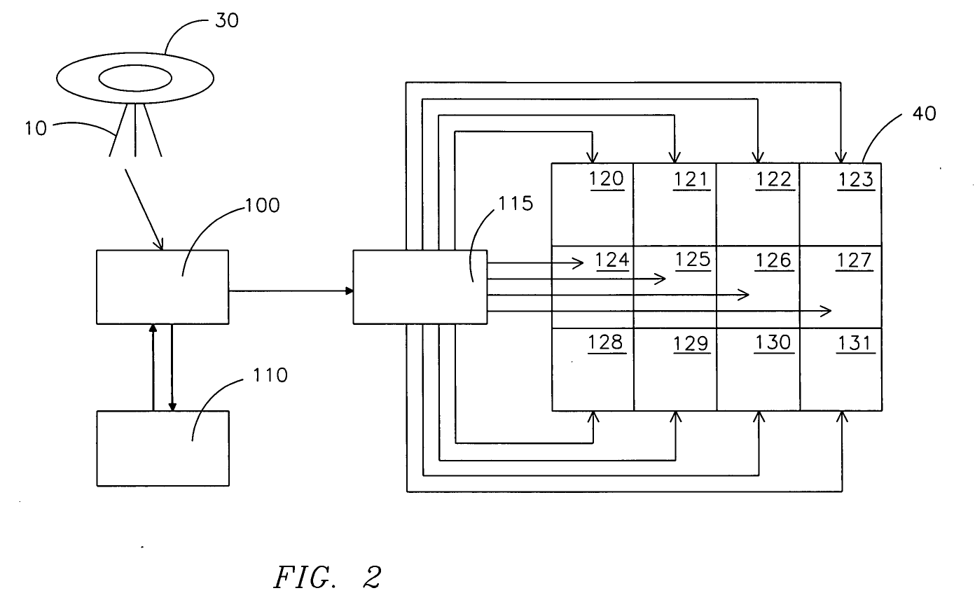

FIG. 2 shows, in one embodiment of the present invention, the path of a video and/or audio signal from satellite receiver 30 to video display 40. Once a signal is received, it is passed to the controller 100. Depending on the current programming instructions, the controller 100 may send any or all channels of the video signal to the storage device 110 for storage. The controller 100 may filter away unnecessary video channels and store only some channels in the storage device 110. The controller 100 may immediately display one channel of the received signal on the video display 40 (in some configurations via a video signal processor 115) as it is being received and it may also store some, none, or all channels in the storage device 110. The controller 100 may also not store or display any channels from the satellite receiver 30. The controller 100 may also choose to store some or all received channels while displaying one video signal from the storage device 110. The storage device may comprise memory media such as a floppy disk, hard drive, flash memory, CD ROM, and/or DVD that will contain, inter alia, the data and program information for controlling the computer controller 100 to enable the controller 100 to perform its functions in accordance with the invention. The storage device 110 may store video data, audio data, and video data with audio data.

In some embodiments of the present invention, the video display 40 is made up of a video display matrix consisting of modular individual video displays, 120, 121, 122, 123, 124, 125, 126, 127, 128, 129, 130, 131. In FIG. 2, for example, twelve such modular video displays are shown, yet any appropriate number of individual video displays may be used, which may be of any appropriate size and configuration. In such an embodiment, the video signal processor 115 dissects a portion of the video signal for displaying on each modular individual video display 120, 121, 122, 123, 124, 125, 126, 127, 128, 129, 130, 131 in such a way that together the modular video displays present the entire video image across the video display matrix. In yet another embodiment, the video signal is a multi-video signal wherein each of the individual video signals of the multi-video signal is displayed on its own corresponding individual display. The video display matrix displays an entire single video image, as discussed above, or one or more individual video images that are displayed simultaneously and/or sequentially.

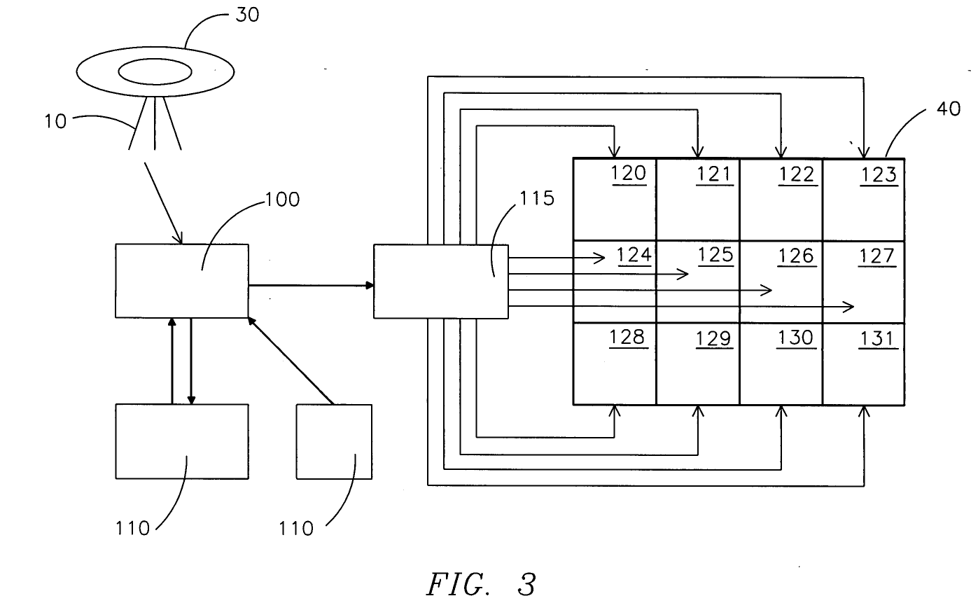

FIG. 3 shows another embodiment of the present invention that includes a GPS system 118. This GPS system communicates geographic position information to the controller 100. The controller 100 may use this information, as directed, in the selection of which video signals to display. For example, the controller 100, depending on the location of the video display 40, for instance when the video display 40 is mobile, may be instructed to display a certain channel of video while the video display 40 is in a certain location, as determined by the GPS system 118. The GPS system 118 may also provide other information to the controller 100, such as time of day, which also may be used independently from or in conjunction with the location information by the controller 100 to display a certain channel or video.

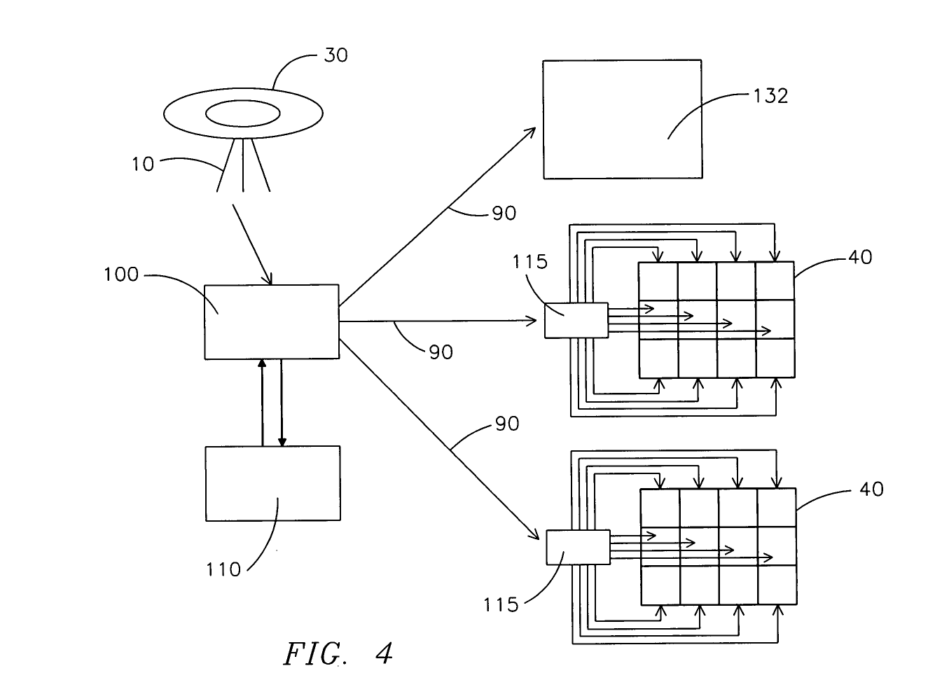

FIG. 4 shows another embodiment of the present invention. In this embodiment, the controller 100 sends video signals to a plurality of video displays 40,132, some via a video signal processor 115 via a non-wireless communication system 90. One video display 132 has no video signal processor 115 because there is not video display matrix. The controller 100 may send the same signal to all video displays 40,132 or different signals to each video display 40,132 depending on the specific programming instructions.

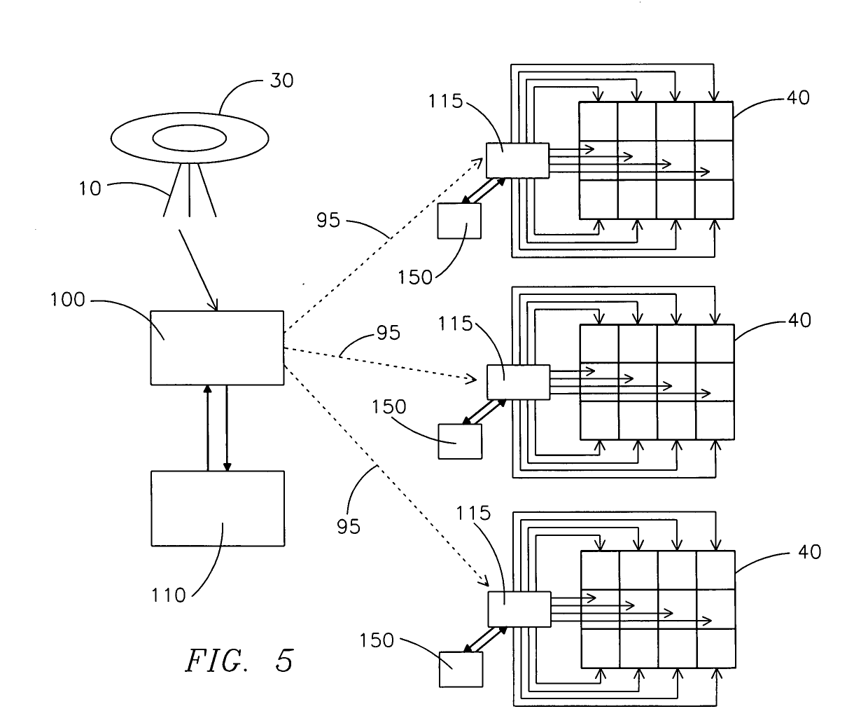

FIG. 5 shows another embodiment of the present invention. In this embodiment, the controller 100 receives video data from the satellite receiver 30 and may store video data in the storage device 110. The controller 100 may communicate with a plurality of video signal processors 115 via a wireless system such as through Bluetooth®, WiFi technology, WiMAX, cell phone, or any other wireless communication method. The dashed lines represent a wireless communications method 95. In this specific embodiment, each video signal processor 115 also has an associated wireless storage device 150 for storing video data prior to presentation on the video displays 40. This storage device 150 may be a hard drive, a tape drive, a recordable DVD, or any other storage device known in the art. In this embodiment, the video signal processor 115 may process video for display on the video displays 40 while the wireless storage device 150 is receiving video data from the controller 100.

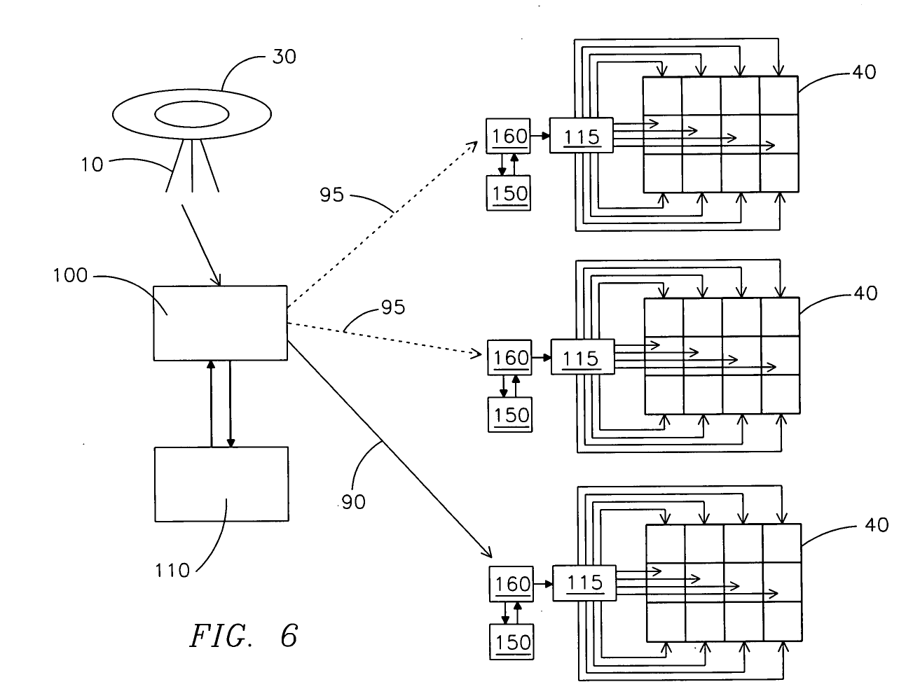

FIG. 6 shows a further embodiment of the invention. In this embodiment, each video display 40 also has a controller 160 associated with it. This controller 160 receives data from controller 100 and may store received video data on the wireless storage device 150 prior to processing in the video signal processor 115. Two of the video displays 40 communicate with the controller via wireless communications 95 while the third communicates with a non-wireless communication system 90.

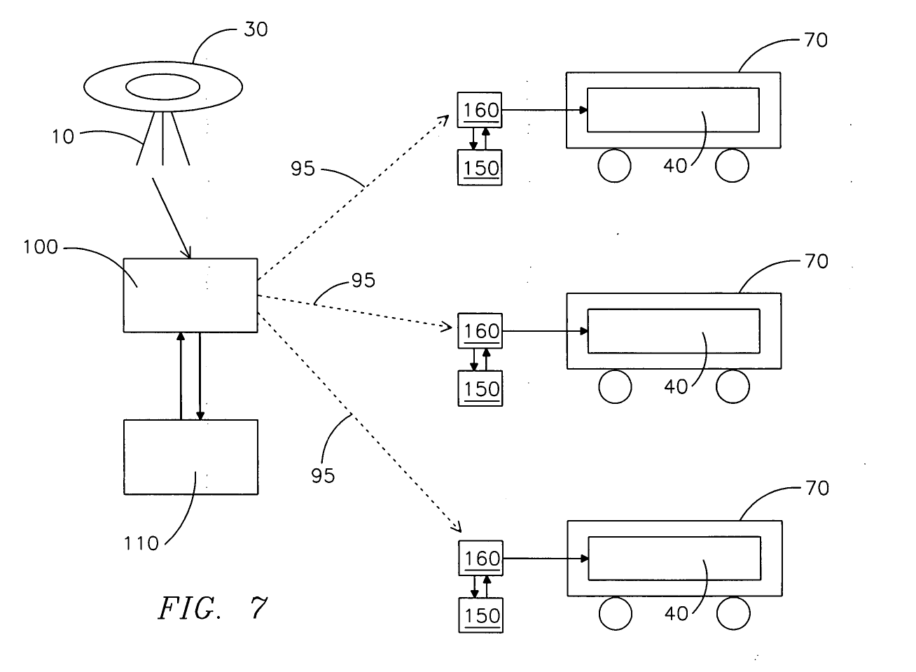

FIG. 7 shows another embodiment of the present invention. The controller 100 receives video data from the satellite receiver 30 and stores video data in storage device 110. In this embodiment, the video displays 40 are mounted on the side of vehicles or mobile trailers 70. In other embodiments, the display may be mounted, for example, on the front, back or top of a vehicle. Other embodiments may also mount the video display on taxis, buses, moving vans, trains, or delivery trucks. Each video display has a controller 160 and a storage device 150. The system controller 100 communicates with the systems on the vehicles or trailers via a wireless communication method 95. Thus the controller 100 includes a wireless transmitter and the controllers 160 have wireless receivers. The vehicles or mobile trailers 70 may receive from the controller 100 programming instructions and video data that is displayed while the vehicle or trailer 70 is in the field.

The storage device 110 may be any storage device that is capable of storing video data. The size varies with the application and amount of video data required. The storage device may be a hard drive, a read/write DVD drive, tape drive, or any other electronic or analog storage device.

The controller 100 of may also be coupled with at least one video signal processor 115 by wireless communication method 95 such as Bluetooth® technology, WiFi, WiMAX, cellular phone, wireless internet, or wireless phone protocols or by non-wireless communication 90 such as DSL, ISDN, RCA® cables, coax, the internet, an intranet, or any other communication connection known in the art. The video signal processor 115 receives video data from the controller 100 and prepares it for presentation on a video display matrix. Some video data may not need processing and may be sent directly to the video display. In one embodiment of the present invention, multiple video displays may be arranged in a video display matrix together forming one large video display. In such an embodiment, the video signal processor splits a single channel video signal into multiple video signals; each split signal is then presented on a single video display unit of the video display matrix. Each video display unit displays a portion of the total video signal in conjunction with the video display unit's position in the video display matrix.

In another embodiment, the video display may also be a projector system. In such an embodiment, the video display is presented, for example, on a wall, ceiling, screen, floor, or other surface.

In another embodiment of the present invention, multiple video displays 40 may be controlled by one controller 100. Thus, a controller may send the same video data signal to each associated video display 40, or the controller 100 may select a different video data signal for some or all associated video displays 40. FIG. 5 and FIG. 6 show systems with a controller 100 controlling multiple video displays. In these figures there are 3 video displays but the number of video displays is not limited to 3. Each video display 40 may have its own video signal processor 115, its own controller 160, and/or its own wireless storage device 150. For instance, a video display 40 may be connected to the controller 100 via a communication line that is not continuously open. In such an embodiment there may be a need for the video display 40 to store video data for a period of time and have a controller 160 to control when the video data is displayed. If such video displays 40 have a video display matrix, a video signal processor 115 may be required. Each individual video display unit, whether in a video display matrix or standing alone, may be, for example, a flat panel display. The video displays may be LCD displays, plasma displays, televisions, LED displays, touch screen displays, computer monitors, or any other video display known in the art.

In a specific embodiment, each video display 40 in a video display matrix may be about one foot long by about one foot wide. The video display matrix, for instance, may be covered with an industrial protective cover to protect each video unit from harsh weather, theft, vandalism, or damage. The video units in such an embodiment may be modular, such that each separate unit may be replaced without negatively affecting the other video displays. The industrial cover may, for example, be a Lexan™ or Plexiglas™ box that encase the video display or video displays and provides a watertight seal that keeps out rain, snow and sleet. This box is also strong enough to keep potential thieves from breaking through and stealing the video displays. Other suitable hard clear coverings that can protect the video display or video displays from theft, vandalism, the elements or damage may be suitable.

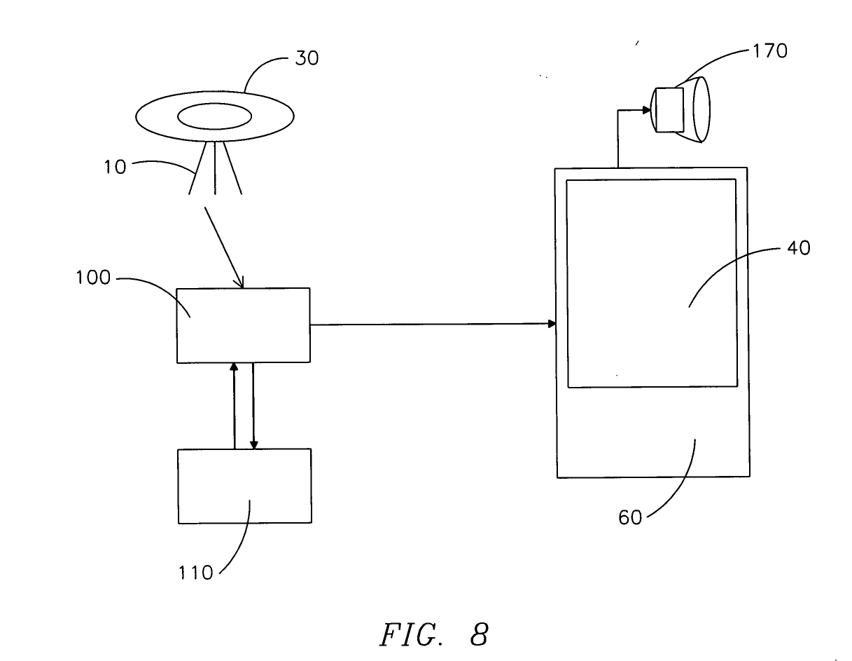

Video data includes both video and audio signals. The data may present still video images on the video displays or video images with motion. Some embodiments may require still images, such as video displays on the side of a vehicle. Because video signals often include audio signals, another embodiment may present audio data via a speaker system along with, or in some desired instances, separate from, the video signal. FIG. 8 shows an embodiment with a speaker system 170. In this embodiment, the video display 40 is housed in a kiosk 60. In embodiments with audio data, the audio data is stored in the storage device 110 along with the video data or may be stored as a separate but related data. Also, the video signal processor does not process audio signals. The audio signal may, however, be amplified, equalized and/or conditioned by known systems prior to presentation through the speaker system 170.

In a further embodiment, the system incorporates a GPS system 118 that is coupled with the controller 100. FIG. 3 represents a GPS system 118 coupled with the controller 100. With a GPS system 118, a mobile system may present specific data according to the location of the system. For instance, the mobile system may present advertising specific to a particular location as the mobile video display system passes therethrough. The system may also change the video data according to the time of day, day of week, time of year, or on holidays by sending programming instructions to the controller 100 that changes the presentation accordingly. The system may also change the video data presented according to the weather. The video display 40 may present a variety of video data that include advertisements, sports, cartoons, AMBER alerts, news, weather reports, terrorism threats, traffic reports, and security warnings.

In another embodiment of the present invention, the system may be mounted on a stationary surface such as a billboard, a kiosk, marquis, business signage, the side of a building, or a wall. Such video displays may also be mounted within a mall, an airport, a bus station, a grocery store, convention center, sports stadium, sports venue, race track, cafeteria, airport subway station, waiting room, a restaurant, a bar, and a train or bus station. Within each building or location, the system may present advertisements specific to the given location or the type of people generally gathered at the location. For instance, the system may present hot dog advertisements at baseball stadiums, clothing ads within shopping malls, or dining ads at popular restaurant areas.

In another aspect, the system may also display live video broadcasts obtained from the satellite uplink station 10 via satellite 20. When the controller 100 receives such instructions, video data is sent directly to the video display 40 by the controller 100. For example, normal programming may be interrupted by a system to display live video data. Such data may include AMBER alerts, vital news, weather reports, terrorism threats, traffic reports, security warnings, or any other important information. In today's world of heightened terrorist threats, the speedy dissemination of terrorist warnings, especially at airports or train stations is a major concern of the Department of Homeland Security. This embodiment may also work directly with the federal Emergency Alert System (EAS). With this embodiment, terrorist warnings may be disseminated to the public quickly, securely, and reliably. Recorded terrorist threat message may be stored at the uplink station and quickly sent to specific systems for immediate presentation. This may be especially valuable when a terrorist threat targets a specific location. In such a situation, warnings may be sent to the specific location. Severe weather warnings may also be presented, such as tornado or hurricane warnings. Also, AMBER alerts, notifying the public of kidnaped children and alerting the public to be on the look out for a specific person or car associated with the kidnaping, may also be displayed. Interruptions may also include travel information, such as delayed flights or trains. All of this information may be directed only to specific locations where it is relevant.

The system may also be coordinated with other federal agencies such as Department of Homeland Security, the Federal Emergency Management Agency, the Department of Commerce, the National Oceanic and Atmospheric Administration, the National Weather Service, and local government agencies, such State Emergency Communications Committees or Local Emergency Communications Committees. For example, interruptions to advertising may be automatically initiated by the EAS. Such a warning system provides broader coverage to the general public. Currently, the EAS presents messages via television or radio. This invention may present emergency messages to the public when they are not near a television or radio. The dissemination of this vital information may be presented to a larger segment of the population who otherwise would not be warned by prior traditional means.

This system may play a vital role in national security. Indeed, the Federal Communication Commission has stated that it is vital that the American public have access to emergency information in times of crisis. This system may provide coverage beyond that capable by the current EAS system.

The controller 100, in the present invention, may be a commercially available stand alone PC equipped with an input for receiving video data from the satellite receiver 30, an internal or external storage device, and one or more video outputs. The controller 100 also has a central processing unit that performs the calculations and logic necessary to carry out the programming instructions received from the satellite uplink station 10. The controller 100 may also have other external interfaces such as a mouse interface and keyboard interface, a separate video display interface, and a GPS interface. The controller 100 may also include read only memory and random access memory. The controller's main functions include receiving and following programming instructions; receiving and storing video data; and coordinating video data presentation to associated video displays. All these functions may be programmed into software and run on a standard PC computer. Programming instructions are stored on the storage device 110 as computer executable code. The programming instructions, when followed, instruct the controller 100 to send video data to coupled video displays 40. The instructions may also determine the duration video data is displayed and when new video data should be started. The instructions may also incorporate input from a GPS system 118 sending video data to video displays 40 when the geographic location changes. The programming instructions may also be overridden by new live programming in the event of an emergency. The controller 100 also receives and stores video data. Video data is received at the satellite receiver 30. Received video data may be in a multi-channel format. The controller isolates single channels of a multi-channel video signal and separately stores the video data in the storage device 110. By following the programming instructions, the controller 100 selects video data from the video storage device 110 and sends it to the appropriate video display 40 or video displays 120-131.

One specific embodiment may include a satellite receiver 30 located outside a single subway station. A controller 100 directly wired with this satellite receiver 30 receives programming instructions, as well as video data from the satellite receiver 30 sent from the satellite uplink station 10 and stores received data in an associated storage device 110. To conserve communication bandwidth through the satellite, video data is most often sent in a multi-channel format. After separating the individual video data signals, the controller 100 may, depending on the programming instructions, store some, all, or none of the received video data. Inside the subway station, there may be, for example, a number of video displays 40. Each video display 40 may be mounted on a wall, housed within a kiosk 60, or presented such that the video display is visible to pedestrians. These video displays 40 are covered by a hard Lexan™ cover to protect the video display 40from theft, vandalism or damage. These video displays 40 may communicate with the controller 100 in a number of different ways. In this example, a portion of the video displays 40 communicate with the controller 100 via WiFi and the others communicate with the controller 100 via a coax cable. Because of the low bandwidth associated with some wireless communication methods 95, a video display device 40 may also include a controller 100 and a storage device 110 that receive video data and store it until the data is received in its entirety. Coax cables are typically capable of carrying a high bandwidth video data signal; therefore, the video displays 40 connected to the controller 100 via a coax cable may not, for example, utilize a separate controller 100 or storage device 110. This specific embodiment may also easily be configured and adapted for use in an airport, train station, shopping mall, convention center, or sports facility.

The present invention also includes methods for selecting advertising for the advertising system. Specifically, according to the programming instructions received by the controller 100 via the satellite receiver 30, the controller 100 sends video data to each video display 40. Each video display 40, for example, may receive the same video data to display. The video displays 40 may also receive different video data depending on the programming instructions. The programming instructions may vary depending on the time of day or the day of week. For instance, in a typical busy subway station during rush hour, the programming instructions may instruct the controller 100 to send video data displaying business related advertising because the crowds will likely be heading to work. Later in the morning when the crowds begin to thin and people start heading out for lunch, the video data sent to the video displays 40 may change to advertising for restaurants or shopping. Later in the afternoon, when the crowds are heading home, the programming instructions may instruct the controller 100 to send video data associated with more leisurely activities such as ads for TV shows or movie trailers. The weekends and holidays may also present varied programming instructions.

A fee may be associated with these programming options. The fee may be determined by a number of variables, including among others, geographic location of the system, duration of the commercial advertising or programming, size of video display 40 used, day of the week, time of day, and the number of other videos displays 40 used. For instance, the fee for advertising may depend on the traffic around a specific location. The fee may also vary according to the time of day, day of week, or the duration a specific ad is displayed. The fee for advertising in a commercial district may be significantly less on a weekend than a week day. Likewise the fee for advertising along a congested road during rush hour will be more expensive than in the late evening. Fees during the Christmas shopping season may also beget a higher fee. The fee also may depend on the size and location of the video display with larger video displays 40 generally being more costly than smaller video displays 40. The fee may further depend on the length of time the advertising is displayed to the public. Video displays 40 that are mounted on a vehicle may demand a higher fee if driven through a crowded area, than if driven through a sparsely populated area. In general, the fee for advertising may be calculated by any combination of the following considerations: geographic location, social movements, seasons, time, demographics, political persuasion, time and/or psychological effects.

The programming instructions may be interrupted by live data feeds from the satellite uplink station 10 to the satellite receiver 30 sending video data to a video display 40 or video displays. For instance, in the previous subway example, if a tornado or hurricane is moving into the vicinity, the system may alert the crowds of the severe weather and may instruct them to stay in the subway until the weather passes. In other instances, the system may be interrupted by an AMBER alert informing the public of a missing child and asking them to be on the look out for a specific person or car. Also, the system may be interrupted with terrorist warnings. Such warnings may, for example, alert the public of increased thread levels, specific threats, information for the public to be on the lookout for specific suspicious behavior or people, or any other terrorist related warnings or information.

In another specific embodiment, the satellite receiver 30 may be housed on a vehicle such as a semi truck trailer. A controller 100 and storage device 110 are also directly coupled with the satellite receiver 30. In this embodiment, the video display 40 may be mounted on the side of the vehicle or mobile trailer 70. For example, the video display 40 may comprise a video display matrix with the matrix of modular individual video displays 120-131 covering a large portion of the side of the trailer 70. Video data that is displayed on the video display matrix must first pass through a video signal processor 115. The video data is separated by the video signal processor 115 into separate signals; each signal is a portion of the video data to display on each modular individual video display unit 120-131. The video display 40 in this example is protected from the elements by a sealed protective covering, such as a Lexan™ box. Such a box is designed to keep the video display clean and dry as well as to protect it from damage, theft, or vandalism. The controller 100 may be coupled with a GPS system 118 that communicates the geographical location of the truck. The programming instructions may alter which video data is displayed according to the geographic location of the system. For instance, the video data displayed may vary as the truck is in a residential versus a business area. The video display may also vary in rush hour compared to times of light traffic. It may vary if the truck is near a park or near a sporting venue or near a school. It may also vary according to region if the truck is traveling long distances. In a further embodiment of the invention, an advertiser may request advertising in specific locations at specific times. The controller 100 may alert the driver to move to a specific location at a specific time in accordance with the advertiser's instructions so the advertisement on the vehicle will be displayed to the audience the advertiser chooses.

In a further embodiment of this invention, a fleet of vehicles or trailers may have video displays 40 mounted on them. In this embodiment, the systems do not each have a satellite receiver 30. The satellite receiver 30 is housed at the distribution center where the vehicles leave at the beginning of their route and return at the end. For example, the satellite receiver 30 receives video data and programming instructions for a fleet of delivery trucks and stores the video data in a storage device 110. To conserve satellite bandwidth, the receiver 30 may only receive data at regular times and store the data until the next scheduled communication with the delivery trucks. When the trucks return to the distribution center, the controller 100 may send the video data and programming instructions data via WiFi to the various delivery trucks. Each truck, when it leaves the distribution center, then displays video data while in the field. Each truck is equipped with a controller 100 including a WiFi receiver, a storage device 110, and a video display 40. If the video display 40 is a video display matrix, then the delivery truck also includes a video signal processor 115. Furthermore, each vehicle may also include a GPS system 118 and present location-specific programming. Thus, an entire fleet of vehicles may receive programming instructions and video data at a set location and each may present different videos advertising while in the field.

Another specific embodiment comprises a plurality of video displays located around a central satellite receiver 30. For instance, a single satellite receiver 30 located on the top of a building receives multi-channel video data from the satellite uplink station 10 through a satellite 20. A system controller 100 receives the video data from the satellite receiver 30 and either saves the data or sends it to a plurality of video displays 40, depending on the programming instructions. In this specific embodiment, the system controller 100 isolates single channels from a multi-channel video signal and stores individual video data in a storage device 110. The system controller 100 also includes a wireless transmitter that sends video data to the respective video displays 40. Each of the individual video displays 40 includes a controller 100 with a wireless receiver and a video display 40. Video data is received from the controller 100 by the controller of each video display 40 and presented on the video display 40. Alternatively, if the wireless bandwidth is too small to send, receive, and display video data in real time, a storage device 110 may also be associated with the video display 40 to store video data while it is being received. The controller 100 controls what video data is displayed on each of the individual video displays 40 by sending the video data to each video display according to the programming instructions. These video displays 40 may be located anywhere within the transmission range of the wireless transmitter. For instance, with a satellite receiver 30 and system controller 100 located on the top of building, video displays may be located within the transmission range of the transmitter on bus stops, on billboards, in shopping stores, in movie theaters, in a convention center, or in a bar.

Another embodiment of the present invention may also include a system wherein video data and programming instructions are disseminated from a station via any one of various transmission mediums including telephone lines, cable connections, and/or the internet. In such an embodiment, the controller 100 may be coupled with a main station which communicates video data and programming instructions to controllers 100 in the field through the transmission medium. The controller may include a system for receiving such data from the main station. Such embodiments have similar controller and video display configurations as embodiments that communicate via satellite. The controller 100 may also be associated with a storage device 110 and may alternatively be associated with a GPS system 118. Video displays 40 may also be single video display 40 or a modular individual video display 120-131 including a video signal processor 115.

The present invention also includes video displays 40 that include a telephone communication system that allows a viewer of the advertising to contact an advertiser displayed on the video display 40. This telephone system is controlled by the controller 100 and directly dials the appropriate advertiser associated with the displayed advertisement.

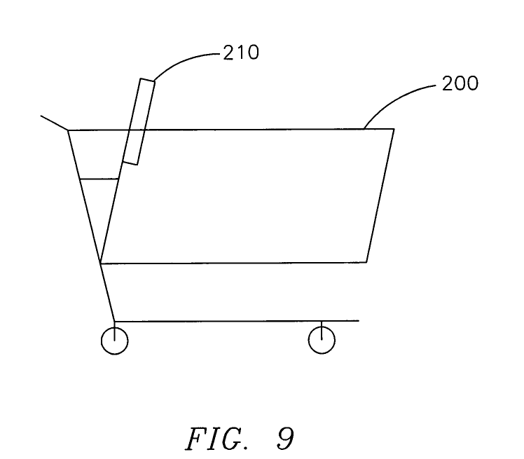

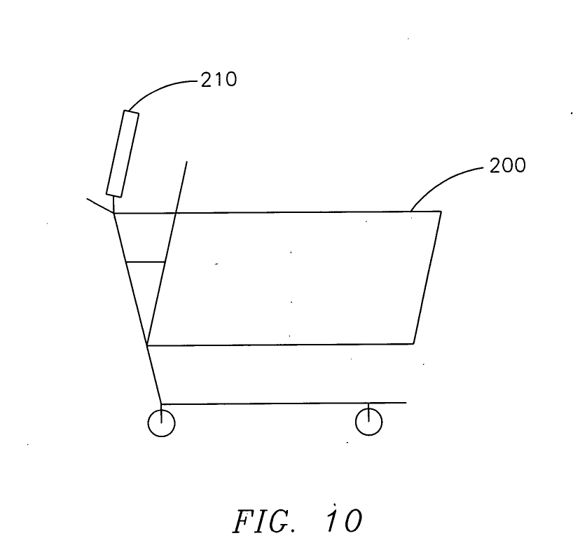

Another embodiment of the present invention as shown in FIG. 9 includes placing a shopping cart video display 210 on a shopping cart 200. FIG. 10 shows an alternate placing of the shopping cart video display 210 on the shopping cart 200. This shopping cart video display 210 is placed in such away so that a shopper can view the shopping cart video display 210 while pushing the shopping cart 200. In such an embodiment, the shopping cart video display 210 communicates with the controller 100 via a wireless communication method 95 such as WiFi, WiMAX, cellular, or Bluetooth® technology. The video display may display such things as advertisements and/or coupons to shoppers. The shopping cart 200 may also have a location detection system. Such a location detection system may be a GPS system 118 or a local in store system. With a location detection system, advertisements or coupons may be presented to a shopper depending on where they are in the store. This embodiment may also include a card reader such as a discount club card or a shopping card popular today with many grocery stores. The display may display coupons specific to the shopper's history as recorded on or associated with the shopping cart 200. The shopping cart display system 210 may also be coupled with rechargeable batteries.

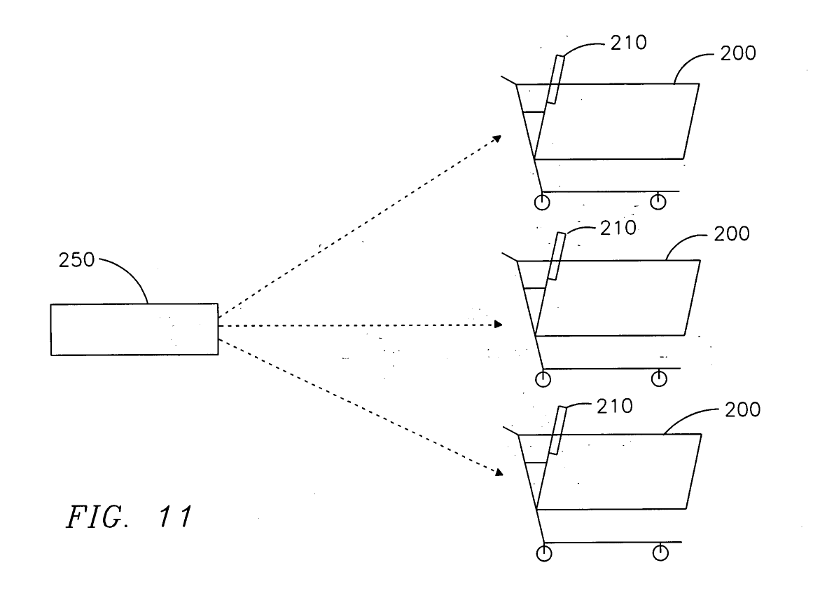

The shopping cart video display system 210 in this embodiment may be in communication with a controller 100 coupled with a satellite system as detailed above or the shopping cart video display system 210 may communicate with a central communication hub 250 as shown in FIG. 11. The central communication hub 250 controls the image displayed on each shopping cart video display 210. The central communication hub 250 and each shopping cart 200 communicate via a wireless communication method such as Bluetooth®, WiFi, WiMAX, cellular technology, or any other wireless technology.

The central communication hub 250, in one embodiment, consists of a computer connected to a wireless communication point such as a WiFi, WiMAX, or Bluetooth® access point. This central communication hub 250 communicates with a plurality of shopping cart video displays 210 through this wireless method. Each shopping cart video display 210 communicates its location to the central communication hub 250 and the hub sends the video display images to display. The shopping cart video displays 210 also send user input to the central communication hub 250 that is received from the user through a touch screen or through a card reader.

For instance, a shopper, upon entering a grocery store, pulls out a shopping cart 200 and is welcomed to the store by a welcome image on the shopping cart video display 210. On the touch screen of the shopping cart video display 210, a series of virtual buttons may direct the user to other images. For instance, a button may be pressed to display a map of the store or to help the shopper find a specific product within the store. Another button may be pressed to show current specials or sales. A further button may be pressed if a shopper needs help choosing between products. Another button may be pressed to help a shopper understand the ingredients or nutritional information of a product. As the user pushes the shopping cart 200 around the store, the ads on the shopping cart video display 210 change depending on where the shopper is within the store. As the user enters the produce section the display may present advertisements for bananas or the display may, for instance, present the user with an electronic coupon for potatoes. Furthermore, if the shopper is shopping for tomato soup, but may be undecided about which brand to purchase, the user may select a touch screen button that causes display of information that may help decide between the various tomato soup brands. For example, the display may compare the price and quality between the tomato soups on the shelf. As the shopper moves about the store the shopper may follow the map on the display or may be directed to a specific product within the store with directions provided on the display. When the shopper reaches the checkout, the system may then communicate any electronic coupons to the checkout. The shopping cart 200 is returned to the shopping cart holding area where the batteries for the system are recharged.

While the invention has been particularly shown and described with regard to specific embodiments thereof, it will be understood by those skilled in the art that the foregoing and other changes in form and details may be made therein without departing from the spirit, essence and scope of the inventions.

Having thusly described my invention what is claimed is:

1. A system comprising:
a satellite receiver in communication with a satellite uplink station via satellite;
a controller coupled with said satellite receiver;
a storage device in association with said controller configured to store video data received from said controller via said satellite receiver via said satellite; and
at least one video display coupled with said controller.

2. The system of embodiment 1, further comprising at least one video signal processor coupled with said video display.

3. The system of embodiment 1, wherein said controller isolates one channel of a multi-channel video signal for presentation on said video display.

4. The system of embodiment 1, further comprising a speaker system associated with said video display.

5. The system of embodiment 1, wherein said controller isolates at least one channel, of a multi-channel video signal for storage in said storage device.

6. The system of embodiment 1, wherein said video display is mobile.

7. The system of embodiment 6, wherein said video display is mounted on a vehicle.

8. The system of embodiment 6, wherein said video display is mounted on a shopping cart.

9. The system of embodiment 1 further comprising a positioning system, which communicates geographic location of said system to said controller.

10. The system of embodiment 1, wherein said video display is mounted on a stationary surface.

11. The system of embodiment 10, wherein said surface is selected from the group consisting of a billboard, a kiosk, marquis, business signage, or a wall.

12. The system of embodiment 10, wherein said video display is mounted inside a building.

13. The system of embodiment 12, wherein said building is selected from the group consisting of a mall, an airport, a bus station, a grocery store, a convention center, a restaurant, a bar, and a train station.

14. The system of embodiment 2, wherein said video display comprises a plurality of video display units.

15. The system of embodiment 1, wherein said video display is a flat screen display.

16. The system of embodiment 1, wherein said video display is selected from the group consisting of LCD displays, plasma displays, televisions, LED displays, touch screen displays, and computer monitors.

17. The system of embodiment 1, wherein said video display is about one foot wide by about one foot high.

18. The system of embodiment 14, wherein said video processor splits a single channel video signal into multiple video signals, each split signal for presentation on a single video display unit of said video display; wherein each video display unit displays a portion of said video channel.

19. The system of embodiment 1, wherein said video display is protected by a protective cover.

20. The system of embodiment 19, wherein said protective cover is an industrial cover used to protect the video display from the elements.

21. The system of embodiment 19, wherein said protective cover protects the video display from theft, vandalism, and damage.

22. The system of embodiment 14, wherein each said video display unit is modular, allowing each video display unit to be replaced individually.

23. The system of embodiment 1, wherein said video display comprises a projector capable of projecting said video display onto a surface.

24. The system of embodiment 23, wherein said surface is selected from the group consisting of a screen, a wall, a ceiling, and a floor.

25. The system of embodiment 1 further comprising a global positioning system, which communicates the geographic location of said system to said controller.

26. The system of embodiment 25, wherein said controller sends different videos from said storage device to said video display for display on said video display responsive to the geographic position of the system as determined by said global positioning system.

27. The system of embodiment 1, wherein said controller sends different videos from said storage device to said video display depending on one or more conditions selected from the group consisting of the time of day, the of the week, whether the day is a holiday, the month, the year, and the weather.

28. The system of embodiment 1, wherein said system displays information selected from the group consisting of advertisements, sports, cartoons, AMBER alerts, news, weather reports, terrorism threats, traffic report, and security warnings.

29. The system of embodiment 1, wherein said system displays live satellite broadcasts obtained from said satellite uplink station via said satellite.

30. The system of embodiment 29, wherein said video display is remotely interrupted via satellite.

31. The system of embodiment 30, wherein said interruption comprises a video signal that is selected from the group consisting of AMBER alerts, vital news, weather reports, terrorism threats, traffic reports, and security warnings.

32. The system of embodiment 30, wherein said interruption comprises video data that is selected from the group consisting of live video data, recorded video data, and video data stored in said storage device.

33. The system of embodiment 1, wherein said controller receives programming instructions from said uplink station via said satellite.

34. The system of embodiment 33, wherein said programming instructions are selected from the group consisting of start time to display video signals, end time of video signals, geographic location in which to display video file, which received channels to store in said storage device, program override, display current signal, and display sequence of a series of video files.

35. The system of embodiment 1, wherein said controller sends video data to said video display via a communication method selected from the group consisting of: wireless networking, Bluetooth® technology, coax cable, WiFi, WiMAX, DSL, ISDN, RCA® cables, the internet, and an intranet.

36. The system of embodiment 1, wherein said controller and said storage device send data to and store data for a plurality of said video displays.

37. A method of comprising selecting advertising and programming to display in the system of embodiment 1.

38. The method of embodiment 37, further comprising a global positioning system, which communicates the geographic location of said system to said controller.

39. The method of embodiment 37, wherein said video display is mobile.

40. The method of embodiment 37, wherein said system comprises a plurality of video display units.

41. The method of embodiment 37, wherein said advertising or programming is commercial advertising or programming.

42. The method of embodiment 41, wherein said commercial advertising or programming displayed is associated with a fee.

43. The method of embodiment 42, wherein said fee for said commercial advertising or programming is determined by a number of variables selected from at least one of the group consisting of geographic location of the system, duration of the commercial advertising and programming, size of the video display used in said system, day of the week, time of day, and the number of other video displays in said system.

44. The system of embodiment 1, wherein said video display is mounted on a shopping cart.

45. The system of embodiment 44, wherein said video display communicates with said controller via WiFi.

46. The system of embodiment 44, wherein said video display communicates with said controller via WiMAX.

47. The system of embodiment 44, wherein said video display communicates with said controller via Bluetooth® technology.

48. The system of embodiment 44, wherein said video display is positioned to be viewed by an operator of said shopping cart.

49. The system of embodiment 44, wherein said video display displays advertisements according to the location of the shopping cart.

50. The system of embodiment 44, wherein said video display provides coupons.

51. The system of embodiment 44, wherein said video display includes a card reader.

52. The system of embodiment 44, wherein said video display is a touch screen display.

53. A system comprising:
a central communication hub; and
at least one system comprising a shopping cart and a video display in communication with said communication hub and attached to said shopping cart;
wherein said communication hub directs the images displayed on said video display.

54. The system of embodiment 53, wherein said communication hub communicates with said video display via Bluetooth® technology.

55. The system of embodiment 53, wherein said communication hub communicates with said video display via WiFi technology.

56. The system of embodiment 53, wherein said communication hub communicates with said video display via WiMAX technology.

57. The system of embodiment 53, wherein said video display is a touch screen display.

58. The system of embodiment 57, wherein said touch screen display communicates user input to said communication hub.

59. The system of embodiment 53, wherein a card reader is coupled with said video display.

60. The system of embodiment 53, wherein said communication hub is a computer.

61. The system of embodiment 53, wherein a location sensor is coupled with said video display that communicates the location of the shopping cart to said communication hub.

62. The system of embodiment 61, wherein said communication hub varies the images displayed on said video display responsive to the location of the shopping cart.

63. The system of embodiment 53, wherein a speaker system is coupled with said video display.

64. The system of embodiment 53, wherein said video display is coupled with rechargeable batteries.

65. The system of embodiment 64, further comprising the means to charge said rechargeable batteries.

66. The system of embodiment 53, wherein said video display provides coupons to a shopper.
